(19) United States
(12) Patent Application Publication
(10) Pub. No.: US 2014/0134478 A1
(43) Pub. Date: May 15, 2014

(54) SECONDARY BATTERY AND METHOD FOR ITS MANUFACTURING

(71) Applicant: KARLSRUHER INSTITUT FUER TECHNOLOGIE, Karlsruhe (DE)

(72) Inventors: XIANGYU ZHAO, Karlsruhe (DE); Maximilian Fichtner, Oftersheim (DE); Horst Hahn, Seeheim-Jugenheim (DE)

(73) Assignee: KARLSRUHER INSTITUT FUER TECHNOLOGIE, Karlsruhe (DE)

(21) Appl. No.: 14/074,725

(22) Filed: Nov. 8, 2013

(30) Foreign Application Priority Data
Nov. 12, 2012 (EP) 12401224.6

(51) Int. Cl. H01M 10/36

(52) U.S. Cl. CPC H01M 10/36
USPC 429/199; 29/623.1

(57) ABSTRACT

The present invention provides a secondary battery which includes a negative electrode (anode) comprising at least one of a first metal, a first alloy, and a host material, which reacts with or intercalates a chloride ion as an anode material, a positive electrode (cathode) comprising at least one of a chloride of a second metal, of a second alloy, and a chloride intercalation compound, as a cathode material, a separator configured to separate the cathode material from the anode material, and an electrolyte with a chloride ionic conductivity. The present invention also provides a method for manufacturing the secondary battery.

### CROSS REFERENCE TO PRIOR APPLICATIONS

Priority is claimed to European Patent Application No. EP 12401224.6, filed Nov. 12, 2012. The entire disclosure of said application is incorporated by reference herein.

### FIELD

The present invention relates to a secondary battery and to a method for its manufacture.

### BACKGROUND

High energy density, abundant material resources, high safety, and environmental friendliness are important features for secondary, i.e., rechargeable, batteries which are receiving particular attention in the areas of portable electronic devices, electric vehicles and other energy storage systems.

Electrochemical cells, also denoted as batteries, based on a cation shuttle, including H⁺/OH⁻, Li⁺, Na⁺, K⁺, Mg²⁺, Al³⁺, and Zn²⁺, are known. A rechargeable battery which uses a fluoride anion as an anion shuttle was described in U.S. Pat. No. 7,722,993 B2 as well as in M. A. Reddy and M. Fichtner, J. Mater. Chem., 2011, 21, 17059-17062. In the latter, the battery is operated at 150° C. by employing a solid electrolyte of a LaF₃/BaF₂ composite which exhibits a fluoride conductivity of 0.2 mS cm⁻¹ at about 150° C. The overall reaction for the metal fluoride/metal secondary battery is expressed as

mM_{c}Fₙ+nMₐ⇄mM_{c}+nMₐFₘ, (1)

where Mₐ represents a first metal employed as anode, M_{c} denotes a second metal employed as cathode, and m, n gives the number of respective fluoride ions.

Similar to metal fluoride/metal batteries, batteries based on various metal chloride/metal systems theoretically exhibit a large Gibbs free energy change which should yield a high electro motoric force (EMF) during the phase transition which is effected by a chloride ion transfer. Calculated data of specific capacities and energy densities for a number of metal chloride/metal couples are listed in Table 1 and Table 2. C_{c} and Cₐ there denote the theoretical capacities of the cathode and anode materials, respectively. The specific capacity of the battery is calculated based on both cathode and anode materials. The Gibbs free energy ΔᵣG data are derived from known standard thermodynamic properties of the selected materials.

TABLE 1
Specific gravimetric capacities and energy densities
for metal chloride/metal couples

| | | | | | Specific | |
|---|---|---|---|---|---|---|
| | | | | Theoretical | capacity of | Energy |
| | ΔᵣG, | | | capacity C, | battery, | density, |
| Battery reaction | kJ/mol | n | EMF, V | mAh/g | Ah/kg | Wh/kg |
| CoCl₂ (c) + 2Li (a) → | −499.0 | 2 | 2.58 | C_{c} = 412.8; | 372.9 | 962.1 |
| 2LiCl + Co | | | | Cₐ = 3861 | | |
| VCl₃ (c) + 3Li (a) → | −642.0 | 3 | 2.21 | C_{c} = 511.1; | 451.3 | 997.3 |
| 3LiCl + V | | | | Cₐ = 3861 | | |
| BiCl₃ (c) + 3Li (a) → | −838.2 | 3 | 2.89 | C_{c} = 255.0; | 239.2 | 691.3 |
| 3LiCl + Bi | | | | Cₐ = 3861 | | |
| 2BiCl₃ (c) + 3Mg (a) | −1145.4 | 6 | 1.98 | C_{c} = 255.0; | 228.6 | 452.6 |
| → 3MgCl₂ + 2Bi | | | | Cₐ = 2205 | | |
| BiCl₃ (c) + Ce (a) → | −669.8 | 3 | 2.31 | C_{c} = 255.0; | 176.5 | 407.7 |
| CeCl₃ + Bi | | | | Cₐ = 573.8 | | |
| CuCl₂ (c) + Ca (a) → | −573.1 | 2 | 2.97 | C_{c} = 398.7; | 307.2 | 912.5 |
| CaCl₂ + Cu | | | | Cₐ = 1340 | | |
| CuCl₂ (c) + Mg (a) → | −416.1 | 2 | 2.15 | C_{c} = 398.7; | 337.6 | 725.9 |
| MgCl₂ + Cu | | | | Cₐ = 2205 | | |
| CuCl₂ (c) + 2Na (a) → | −592.5 | 2 | 3.07 | C_{c} = 398.7; | 297.0 | 911.9 |
| 2 NaCl + Cu | | | | Cₐ = 2330 | | |
| CuCl₂ (c) + 2Li (a) → | −593.1 | 2 | 3.07 | C_{c} = 398.7; | 361.3 | 1109 |
| 2LiCl + Cu | | | | Cₐ = 3861 | | |
| CuCl (c) + Li (a) → | −264.5 | 1 | 2.74 | C_{c} = 271.7 | 252.9 | 693.1 |
| LiCl + Cu | | | | Cₐ = 3861 | | |
| FeCl₂ (c) + 2Na (a) → | −465.9 | 2 | 2.41 | C_{c} = 425.9 | 311.9 | 751.6 |
| 2NaCl + Fe | | | | Cₐ = 2330 | | |
| NiCl₂ (c) + 2Na (a) → | −509.2 | 2 | 2.64 | C_{c} = 413.5 | 305.2 | 805.7 |
| 2NaCl + Ni | | | | Cₐ = 2330 | | |
| FeCl₃ (c) + Ce (a) → | −650.8 | 3 | 2.25 | C_{c} = 495.6; | 265.9 | 598.2 |
| CeCl₃ + Fe | | | | Cₐ = 573.8 | | |
| 2FeCl₃ (c) + 3Mg (a) | −1107.4 | 6 | 1.91 | C_{c} = 495.6; | 404.7 | 773.0 |
| → 3MgCl₂ + 2Fe | | | | Cₐ = 2205 | | |
| MnCl₂ (c) + 2Li (a) → | −328.3 | 2 | 1.70 | C_{c} = 425.9; | 383.6 | 652.1 |
| 2LiCl + Mn | | | | Cₐ = 3861 | | |

TABLE 2
Specific volumetric capacities and energy densities
for metal chloride/metal couples

| | | | | | Specific | Volumetric |
|---|---|---|---|---|---|---|
| | | | | Theoretical | capacity | energy |
| | ΔᵣG | | | capacity C, | of battery, | density, |
| Battery reaction | kJ/mol | n | EMF, V | mAh/g | Ah/L | Wh/L |
| CoCl₂ (c) + 2Li (a) → | −499.0 | 2 | 2.58 | C_{c} = 412.8; | 827.9 | 2136.0 |
| 2LiCl + Co | | | | Cₐ = 3861 | | |
| VCl₃ (c) + 3Li (a) → | −642.0 | 3 | 2.21 | C_{c} = 511.1; | 891.4 | 1970.0 |
| 3LiCl + V | | | | Cₐ = 3861 | | |
| BiCl₃ (c) + 3Li (a) → | −838.2 | 3 | 2.89 | C_{c} = 255.0; | 761.0 | 2199.3 |
| 3LiCl + Bi | | | | Cₐ = 3861 | | |
| 2BiCl₃ (c) + 3Mg (a) | −1145.4 | 6 | 1.98 | C_{c} = 255.0; | 920.8 | 1823.2 |
| → 3MgCl₂ + 2Bi | | | | Cₐ = 2205 | | |
| BiCl₃ (c) + Ce (a) → | −669.8 | 3 | 2.31 | C_{c} = 255.0; | 923.4 | 2133.1 |
| CeCl₃ + Bi | | | | Cₐ = 573.8 | | |
| CuCl₂ (c) + Ca (a) → | −573.1 | 2 | 2.97 | C_{c} = 398.7; | 818.1 | 2429.8 |
| CaCl₂ + Cu | | | | Cₐ = 1340 | | |
| CuCl₂ (c) + Mg (a) → | −416.1 | 2 | 2.15 | C_{c} = 398.7; | 998.6 | 2147.0 |
| MgCl₂ + Cu | | | | Cₐ = 2205 | | |
| CuCl₂ (c) + 2Na (a) → | −592.5 | 2 | 3.07 | C_{c} = 398.7; | 614.5 | 1886.5 |
| 2 NaCl + Cu | | | | Cₐ = 2330 | | |
| CuCl₂ (c) + 2Li (a) → | −593.1 | 2 | 3.07 | C_{c} = 398.7; | 813.3 | 2496.8 |
| 2LiCl + Cu | | | | Cₐ = 3861 | | |
| CuCl (c) + Li (a) → | −264.5 | 1 | 2.74 | C_{c} = 271.7; | 724.7 | 1985.7 |
| LiCl + Cu | | | | Cₐ = 3861 | | |
| FeCl₂ (c) + 2Na (a) → | −465.9 | 2 | 2.41 | C_{c} = 425.9; | 611.7 | 1474.2 |
| 2NaCl + Fe | | | | Cₐ = 2330 | | |
| NiCl₂ (c) + 2Na (a) → | −509.2 | 2 | 2.64 | C_{c} = 413.5; | 637.9 | 1684.0 |
| 2NaCl + Ni | | | | Cₐ = 2330 | | |
| FeCl₃ (c) + Ce (a) → | −650.8 | 3 | 2.25 | C_{c} = 495.6; | 1048.7 | 2359.8 |
| CeCl₃ + Fe | | | | Cₐ = 573.8 | | |
| 2FeCl₃ (c) + 3Mg (a) | −1107.4 | 6 | 1.91 | C_{c} = 495.6; | 1045.3 | 1996.5 |
| → 3MgCl₂ + 2Fe | | | | Cₐ = 2205 | | |
| MnCl₂ (c) + 2Li (a) → | −328.3 | 2 | 1.70 | C_{c} = 425.9; | 782.9 | 1330.9 |
| 2LiCl + Mn | | | | Cₐ = 3861 | | |

From both Table 1 and Table 2, it is apparent that a metal chloride/metal secondary battery would exhibit high energy densities. For practical applications, the volumetric energy densities given in Table 2 are usually of higher importance compared to the gravimetric energy densities given in Table 1 since volume is often a larger problem than weight, for example, in cellular phones. Despite the attractive features presented in Table 1 and Table 2, secondary batteries, which work on the basis of a transfer of chloride ions, have not so far been reported.

A large volume change, especially for the selected cathode materials, occurs during the phase transition between a metal chloride and its corresponding metal. As an example, a drastic volume expansion of 482.3% from Co to CoCl₂ was observed. Values for other couples are presented in Table 3.

TABLE 3
Volume change between some metals and their chlorides

| | Volume change, % | |
|---|---|---|
| Metal/metal chloride | Metal to metal chloride | Metal chloride to metal |
| Li/LiCl | 56.5 | −36.1 |
| Na/NaCl | 13.6 | −12.0 |
| Mg/MgCl₂ | 197.5 | −66.3 |
| Ca/CaCl₂ | 100.0 | −50.0 |
| Ce/CeCl₃ | 221.8 | −68.9 |
| Cu/CuCl | 216.2 | −68.3 |
| Co/CoCl₂ | 482.3 | −82.8 |
| Cu/CuCl₂ | 460.0 | −82.1 |
| Fe/FeCl₂ | 464.5 | −82.3 |
| Ni/NiCl₂ | 453.5 | −81.9 |
| Mn/MnCl₂ | 472.4 | −82.5 |
| V/VCl₃ | 480.0 | −82.7 |
| Bi/BiCl₃ | 210.6 | −67.8 |

This feature must also be considered in a real battery setup since it easily causes an interruption of a mass transfer when an electrode material is contacted with a mechanically rigid solid electrolyte.

Little attention has so far been paid to anionic conductors with chloride conductivity. I. V. Murin, O. V. Glumov, and N. A. Mel'nikova, Russ. J. Electrochem., 2009, 45, 411-416, and N. Imanaka, K. Okamoto and G. Adachi, Angew. Chem. Int. Ed., 2002, 41, 3890-3892, reported that solid inorganic compounds such as PbCl₂, SnCl₂, and LaOCl show a fast chloride transfer at very high temperatures.

V. Murin, O. V. Glumov, and N. A. Mel'nikova, Russ. J. Electrochem., 2009, 45, 411-416, and K. Yamada, Y. Kuranaga, K. Ueda, S. Goto, T. Okuda, and Y. Furukawa, Bull. Chem. Soc. Jpn., 1998, 71, 127-134, furthermore demonstrated that cubic CsSnCl₃ shows a high ionic conductivity of 1 mS cm⁻¹ at about 100° C.

L. C. Hardy and D. F. Shriver, Macromolecules, 1984, 17, 975-977, P. C. Huang and K. H. Reichert, Angew. Makromol. Chem., 1989, 165, 1-7, as well as N. Ogata, J. Macromol. Sci. Polymer. Rev., 2002, 42, 399-439, reported that chloride ionic liquids which are cross-linked in polymers also possess fast ionic conduction. As an example, a composite of poly(diallyldimethylammonium chloride)/tetramethylammonium chloride shows an ionic conductivity of 0.22 mS cm⁻¹ at 25° C.

### SUMMARY

An aspect of the present invention is to provide a secondary battery on the basis of a metal chloride/metal transition and a method for its manufacture which overcomes the limitations of the prior art.

A further aspect of the present invention is to provide a secondary battery which comprises an electrolyte which exhibits high chloride ionic conductivity.

A further aspect of the present invention is to provide a secondary battery which is safely rechargeable.

In an embodiment, the present invention provides a secondary battery which includes a negative electrode (anode) comprising at least one of a first metal, a first alloy, and a host material, which reacts with or intercalates a chloride ion as an anode material, a positive electrode (cathode) comprising at least one of a chloride of a second metal, of a second alloy, and a chloride intercalation compound, as a cathode material, a separator configured to separate the cathode material from the anode material, and an electrolyte with a chloride ionic conductivity.

In an embodiment, the present invention also provides a method of manufacturing the secondary battery. The method includes: (a) providing an anode material comprising at least one of a first metal, a first alloy, and a host material, which reacts with or intercalates a chloride ion so as to form a negative electrode (anode) therewith; (b) providing a cathode material comprising at least one of a chloride of a second metal, a second alloy, or a chloride intercalation compound, so as to form a positive electrode (cathode) therewith; (c) arranging a separator so that the positive electrode (cathode) is physically separated from the negative electrode (anode) when a flow of chloride ions is allowed during an operation of the secondary battery; and (d) adding an electrolyte so that the positive electrode (cathode) is electrically connected with the negative electrode (anode).

### BRIEF DESCRIPTION OF THE DRAWINGS

The present invention is described in greater detail below on the basis of embodiments and of the drawings in which:

FIG. 1a shows discharge curves as well as XRD patterns of a CoCl₂/Li battery with a mixture of 1-Methy-3-Octylimidazolium chloride ([OMIM][Cl]) and 1-Butyl-3-methylimidazolium tetrafluoroborate ([BMIM][BF₄]) as an electrolyte;

FIG. 1b shows XRD patterns that evidence a transition from CoCl₂ to metallic Co at the cathode as well as a LiCl formation at the anode after discharge which indicate that the chloride ion moves from the cathode to the anode during discharging;

FIG. 2a shows a ball-milled CoCl₂ which exhibited a charge capacity of 67.1 mAh g⁻¹, which is 84% of the first discharge capacity. The inset of FIG. 2a shows the CV spectrum for a CoCl₂/Li battery which exhibits a pair of cathodic and anodic peaks in the potential electrochemical window from 3.5 V to 1.6 V;

FIG. 2b shows multistep reversible reactions in a VCl₃/Li secondary battery as presented in the inset in FIG. 2b. The first reduction peak in the CV spectrum appears at 2.86 V and a subsequent broad reduction peak is observed in the voltage range from 2.6 V to 1.5 V while three distinct oxidation peaks appear in a reverse scan;

FIG. 2c shows a battery in which BiCl₃ is utilized as cathode material. The inset of FIG. 2c shows a CV pattern of a BiCl₃/Li battery with multistep reversible reactions during discharge and charge;

FIG. 2d shows a so-called cycling test for the BiCl₃/Li battery. The inset of FIG. 2d shows a CV pattern showing stable multistep reactions in the BiCl₃/Li battery;

FIG. 3a shows XRD patterns of various cathode materials after discharge and charge;

FIG. 3b shows XRD patterns of a VCl₃ cathode;

FIG. 3c shows XRD patterns of Bi metal;

FIG. 3d shows XRD patterns of Bi metal;

FIG. 4a shows XPS data where 4f_{7/2} and 4f_{5/2} signals of Bi were generated at the surface of a BiCl₃ cathode material;

FIG. 4b shows XPS data where metallic Bi^{o} was formed after discharging of the BiCl₃ cathode material; and

FIG. 4c shows XPS data where metallic Bi^{o}, which had been formed during the discharging, was again reversed into BiCl₃ after recharging the battery.

### DETAILED DESCRIPTION

A metal chloride/metal secondary battery having at least the following composition is provided according to the present invention:
a negative electrode (anode) which comprises a first metal or a first alloy or a host material, which is capable to react with or to intercalate a chloride ion Cl⁻, as an anode material,
a positive electrode (cathode) which comprises a chloride of a second metal or of a second alloy or a chloride intercalation compound as a cathode material,
a separator which physically separates the cathode from the anode in order to prevent any contact, and
an electrolyte, for example, in the form of a solid, a gel or a liquid, which exhibits a chloride ionic conductivity, for example, of at least 0.1 mS cm⁻¹, or, for example, of at least 1 mS cm⁻¹.

A chloride intercalation compound hereby describes a complex material where a chloride ion Cl⁻ is reversibly inserted between at least a single other chemical compound, which is generally denoted as a host material.

In an embodiment of the present invention, the anode material includes:
an alkali metal, for example, Li or Na;
an alkaline earth metal, for example, Mg or Ca;
a rare earth metal, for example, La or Ce; or
an alloy which includes at least one of the aforementioned metals.

In an embodiment of the present invention, finely dispersed metal powder can, for example, be used as the anode material in a composite with carbon black or porous nanocarbon or non-porous nanocarbon, including graphene, or other electrically conductive materials, including a metal powder or a metal foam.

In an embodiment of the present invention, the cathode material can, for example, include a chloride of a transition metal or a post-transition metal, for example, of Co or of V or of Bi or of Sn or of Pb or of Sb, or of a mixture of at least two of these chlorides.

In an embodiment of the present invention, the cathode material can, for example, be constituted by a composite which includes carbon black or a porous nanocarbon or a non-porous nanocarbon, including graphene, or other electrically conductive materials, including a metal powder or a metal foam, in addition to the chloride of a transition metal or of a post transition metal. In an embodiment of the present invention, a composite of CoCl₂ or of VCl₃ or of BiCl₃, respectively, with carbon black can, for example, be employed as the cathode material.

In an embodiment of the present invention, the electrolyte can, for example, be selected from:
a chloride ionic liquid, i.e., a chloride salt which is in the liquid state at the operation temperature of the battery. In general, ionic liquids consist of a salt where one or both the ions are large, and the cation has a low degree of symmetry. These factors tend to reduce the lattice energy of the crystalline form of the salt, and hence lower the melting point;
a complex anion which contains a chloride ion, and an organic solvent;
an organic chloride salt; or
an inorganic chloride salt.

Particularly for operation temperatures of the secondary battery above 100° C., the electrolyte is selected from an inorganic chloride salt, either in its solid or in its molten form, for example, from:
a solid solution of a PbCl₂/alkali-metal chloride, for example, with KCl;
a solid solution of a SnCl₂/alkali-metal chloride, for example, with KCl;
CsSnCl₃, CsPbCl₃;
K₂NiCl₄; or
LaOCl, or from La₁₋ₓCaₓOCl₁₋ₓ.

In an embodiment of the present invention, particularly for operation temperatures of the secondary battery within a temperature range from 25° C. to 100° C., the electrolyte can, for example, be selected from an organic chloride salt or from a chloride ionic liquid.

Organic chloride salts include, for example, poly(diallyldimethylammonium chloride) or organic chlorides with cations of imidazolium, pyrrolidinium, piperidinium, or pyridinium without or with side chains. In an embodiment of the present invention, solid chlorides with cations of ammonium, imidazolium, pyrrolidinium, piperdinium or pyridinium can, for example, be employed as additives in a polymer electrolyte.

Examples of chloride ionic liquids include pure ionic liquids, binary ionic liquids or ternary ionic liquids.

Examples of binary ionic liquids include chloride ionic liquids with cations of imidazolium, pyrrolidinium, piperidinium, pyridinium, and quaternary ammonium. Large side chains can, for example, be used since the imidazolium species shows the lowest electrochemical window. The electrochemical window of a material is the voltage range between which the material is neither oxidized nor reduced. In an embodiment of the present invention, ionic liquids with different anions, for example, with BF4⁻, PF6⁻, or [N(CF₃SO₂)₂]⁻, can, for example, be added as solvents to the selected binary ionic liquid.

In an embodiment of the present invention, ternary ionic liquids, such as imidazolium tetrafluoroborate [BMIM][BF4], can, for example, be employed as additives to increase the ionic conductivity of a specific binary ionic liquids electrolyte.

In an embodiment of the present invention, the electrolyte can, for example, be selected from a chloride ionic liquid to which an organic solvent, for example, polycarbonate (PC), a mixture of polycarbonate and dimethyl carbonate (PC/DMC), or a mixture of ethylene carbonate and dimethyl carbonate (EC/DMC), has been added.

In an embodiment of the present invention, the electrolyte can, for example, be selected from a mixture of a complex anion which contains a chloride ion and an organic solvent or an ionic liquid. In order to obtain a complex anion, a transition metal chloride including FeCl₃, FeCl₂, NiCl₂, or CoCl₂ which reacts with a chloride ion to form a corresponding complex anion [FeCl₄]⁻, [FeCl₄]²⁻, [NiCl₄]²⁻ or [CoCl₄]²⁻ which is stable in the electrolyte and cannot be reduced to the corresponding metals in the electrochemical window of the electrolytes, is employed. In contrast with these findings, [AlCl₄]⁻ and [CuCl₄]²⁻ can be reduced to metals.

Another aspect of the present invention relates to a method for manufacturing the secondary battery. According to the present invention, the method comprises the following steps (a) to (d).

According to step (a), an anode material having a first metal or a first alloy or a host material, which is able to react with or to intercalate a chloride ion Cl⁻, is provided and a negative electrode (anode) is formed therewith.

According to step (b), a cathode material having a chloride of a second metal or of a second alloy or a chloride intercalation compound is provided and a positive electrode (cathode) is formed therewith.

According to step (c), an arrangement is composed by arranging a separator in such a way that, while the cathode stays physically separated from the anode in order to avoid any contact between the cathode and the anode, a flow of chloride ions is generated during the operation of the secondary battery.

According to step (d), an electrolyte is added to this arrangement in such a way that, while the cathode still remains physically separated from the anode, an electrically conducting connection between the anode and the cathode results during the operation of the battery.

In an embodiment of the present invention, the cathode material can, for example, be provided during step (b) in the form of a dried powder. The cathode is subsequently formed by ball milling this powder with carbon black or a porous nanocarbon or a non-porous nanocarbon, including graphene, in order to form a composite thereof.

In an embodiment of the present invention, the cathode material can, for example, be provided during step (b) in the form of a dried powder which is first dissolved by a suitable solvent in a solution, which is then added to carbon black or porous nanocarbon or non-porous nanocarbon, including graphene, in such a way that it provides a wet composite. The cathode itself is formed by first freeze-drying the wet composite and subsequently heating it to a temperature, which can, for example, be between 100° C. and 200° C.

The present invention provides a safe and energetic rechargeable battery which is based on the transfer of chloride ions. An advantage of such a battery is attributed to the fact that chloride ions are environmentally friendly and are at the same time abundant.

The present invention will be more apparent from the following description of non-limiting specific embodiments with reference to the drawings.

### EXAMPLES

High-purity (>99.5%) anhydrous CoCl₂, VCl₃, and BiCl₃ powders were dried under vacuum at appropriate temperatures. The positive electrodes (cathodes) were prepared by ball milling one of said metal chlorides and 20 wt.-% carbon black utilizing a silicon nitride vial with silicon nitride balls (20 and 10 mm in diameter) under an argon atmosphere. The ball to powder ratio was 20:1. The milling was performed in a planetary mill with a rotation speed of 300 rpm. The milling time was 1 h.

In an alternative route, a freeze-dry method was employed to prepare the CoCl₂/carbon black composite. The anhydrous CoCl₂ powders were dissolved in anhydrous methanol to form a blue solution which was then added drop-wise into the active carbon in a beaker. The wet composite was cooled in a liquid nitrogen bath and subsequently freeze-dried under vacuum for 5 h, followed by 18 h of drying at 160° C.

Ionic liquids of 1-Methy-3-Octylimidazolium chloride ([OMIM] [Cl], purity>97%) and 1-Butyl-3-methylimidazolium tetrafluoroborate ([BMIM][BF4], purity>98%) were both dried at 85° C. for 72 h under vacuum and with different volume ratios and subsequently employed as an electrolyte.

A glass fiber was utilized as the separator.

The electrochemical measurements were conducted by utilizing two-electrode Swagelok-type cells with lithium metal as the anode material. The cathode materials consisted of CoCl₂/C, VCl₃/C or BiCl₃/C powders, respectively, where C denotes carbon black. Discharge and charge tests were carried out galvanostatically at various current densities over a voltage range from 3.5 V to 1.6 V by using a multi-channel battery testing system at 298 K. Cyclic voltammetry (CV, 1.6 V to 3.5 or 4 V, 50 μV s⁻¹) spectra were taken by using an electrochemical workstation.

Powder X-ray diffraction (XRD) patterns were obtained with a diffractometer with Cu—K_{α} radiation. X-ray photoelectron spectroscopy (XPS) measurements were carried out by utilizing a K-Alpha spectrometer with Al—Kᵤ radiation as the X-ray source.

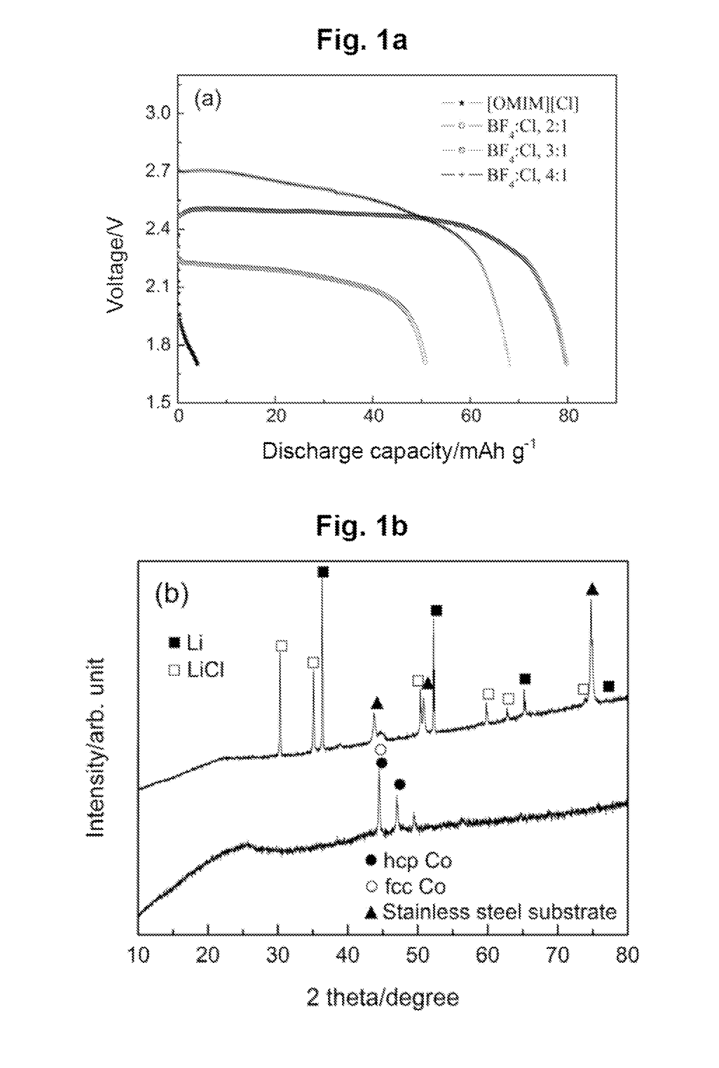

FIG. 1 shows discharge curves as well as XRD patterns of a CoCl₂/Li battery with a mixture of 1-Methy-3-Octylimidazolium chloride ([OMIM][Cl]) and 1-Butyl-3-methylimidazolium tetrafluoroborate ([BMIM][BF4]) as the electrolyte. Since [OMIM][Cl] exhibits a melting point below 0° C. and also has a high viscosity, a battery in which [OMIM][Cl] is used as sole electrolyte will almost not be able to discharge as shown in FIG. 1a. The reason for this behavior is due to a weak chloride mobility in pure [OMIM][Cl] at 298 K.

By adding [BMIM][BF4] as second electrolyte component, the movement of the chloride ion could be significantly increased. Employing a volume ratio of [BMIM][BF4] to [OMIM][Cl] at 3:1, a discharge capacity of about 80 mAh g⁻¹ was measured and a voltage plateau at 2.47 V for the CoCl₂ electrode was observed. At a molar concentration of about 1 M for [OMIM][Cl], the ionic conductivity was 0.91 mS cm⁻¹ at 298 K. After the discharge a transition from CoCl₂ to metallic Co at the cathode as well as a LiCl formation at the anode were evidenced by the XRD patterns shown in FIG. 1b which indicate that the chloride ion moves from the cathode to the anode during discharging.

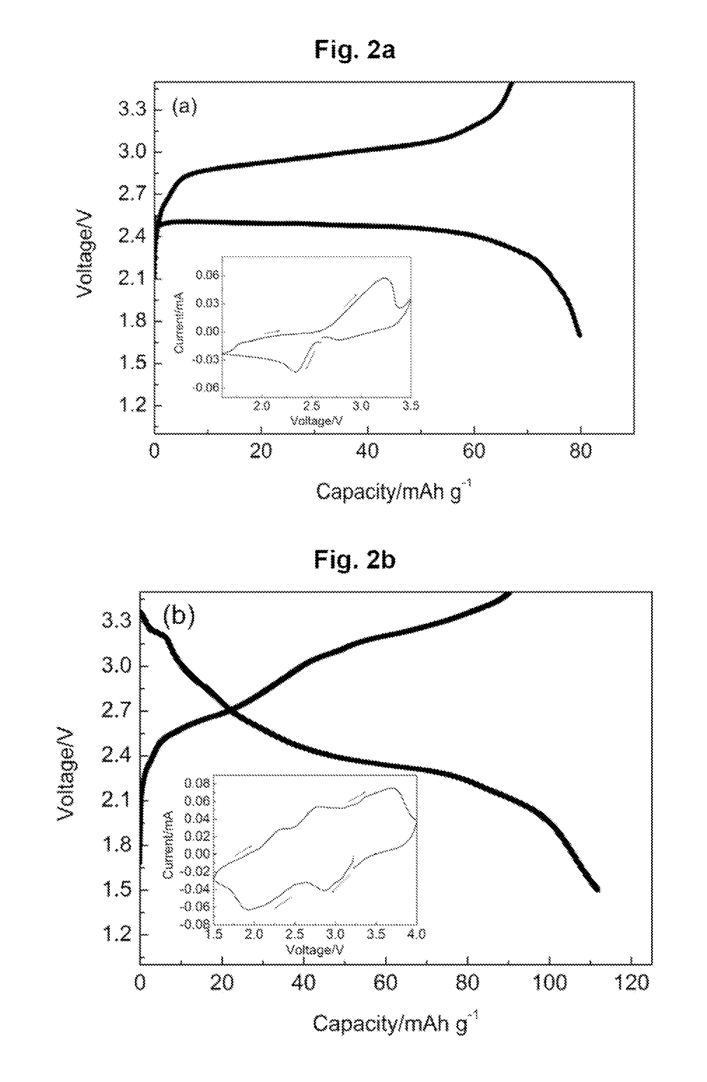

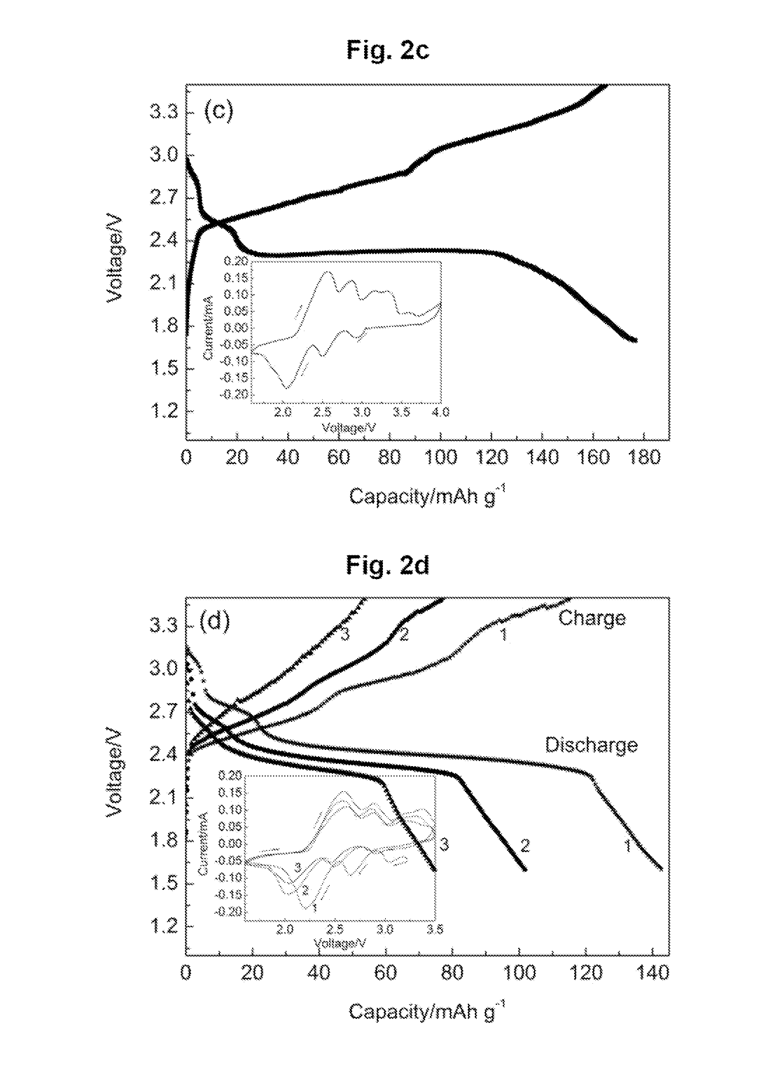

Recharging tests were performed for several couples in the electrolyte with about 1 M [OMIM][Cl] at 298 K. The ball-milled CoCl₂ exhibited a charge capacity of 67.1 mAh g⁻¹ which is 84% of the first discharge capacity as shown in FIG. 2a.

In an alternative route, wet impregnation and the freeze-drying method were employed to prepare a CoCl₂/carbon composite, which contains finely dispersed CoCl₂ particles and which shows a further improvement of the capacity to 105.2 mAh g⁻¹.

This value is, however, still considerably lower than the theoretical capacity of a CoCl₂ cathode with a value of 412.8 mAh g⁻¹ as set forth in Table 1. This feature can be attributed to a partial dissolution of CoCl₂ into the electrolyte. Transition metal chlorides are Lewis acids which react with a Lewis base containing a chloride ion, resulting in a formation of complex ions. For example, CoCl₂ reacts with Cl⁻ to form a blue CoCl₄²⁻ complex which readily dissolves into an electrolyte. Since this process consumes a part of the active material, it leads to a lower discharge capacity of the CoCl₂ electrode.

The CV spectrum for a CoCl₂/Li battery, as shown in the inset in FIG. 2a, exhibits a pair of cathodic and anodic peaks in the potential electrochemical window from 3.5 V to 1.6 V, which can be attributed to the chloride shuttle during discharge and charge. The single cathodic or anodic peak is caused by a one-step phase transformation of the reduction of CoCl₂ and also the subsequent oxidation during charging.

Multistep reversible reactions were observed in a VCl₃/Li secondary battery as presented in the inset in FIG. 2b. The first reduction peak in the CV spectrum appears at 2.86 V and a subsequent broad reduction peak is observed in the voltage range from 2.6 V to 1.5 V while three distinct oxidation peaks appear in a reverse scan. These redox couples can be ascribed to reactions among the vanadium species of V³⁺, V²⁺, V⁺ and V, which results in a discharge capacity of 111.8 mAh g⁻¹ of the VCl₃ electrode.

FIG. 2c shows a battery in which BiCl₃ is utilized as the cathode material. BiCl₃ is a mild Lewis acidic chloride and therefore relatively non-toxic and has subsequently been employed as an eco-friendly catalyst system in synthetic green chemistry. It has additionally been found that BiCl₃ is stable in the electrolyte even after more than three months of immersion. A flat voltage plateau of 2.34 V and a high discharge capacity of about 176.6 mAh g-1 were observed, which corresponds to 69% of the theoretical capacity 255 mAh g⁻¹ (see Table 1). Its charge capacity of 165 mAh g⁻¹ moreover shows that 93% of the discharge capacity could be recovered. As shown in the CV pattern in the inset in FIG. 2c, a BiCl₃/Li battery presents multistep reversible reactions during discharge and charge.

A so-called cycling test for the BiCl₃/Li battery is presented in FIG. 2d. The BiCl₃ cathode shows a discharge capacity of 142.9 mAh g⁻¹ at a current density of 3 mA g⁻¹ and its capacity decreases in the subsequent cycles. Since the phase transformation of Bi metal to BiCl₃ causes a large volume expansion of 210.6%, electrical contacts between some BiCl₃ particles and carbon at the cathode seem to be interrupted which would result in the observed capacity decay. A similar reason is applicable to the observations at the anode.

Stable multistep reactions in the BiCl₃/Li battery could be observed in the CV pattern as shown in the inset in FIG. 2d. L. Heerman and W. D'Olieslager, J. Electrochem. Soc., 1991, 138, 1372-1376, reported that two intermediate oxidation states, i.e., Bi₅³⁺ and Bi₅⁺ clusters, in the electrochemical reduction of Bi³⁺ to Bi from a room temperature molten salt exist. The CV spectrum here shows that the major electrical charge is derived from the redox reaction at a low voltage. It is assumed that two ways of a solid phase transformation occur at the cathode, a multistep process including the mentioned intermediate oxidation states and a direct transformation between BiCl³ and Bi metal.

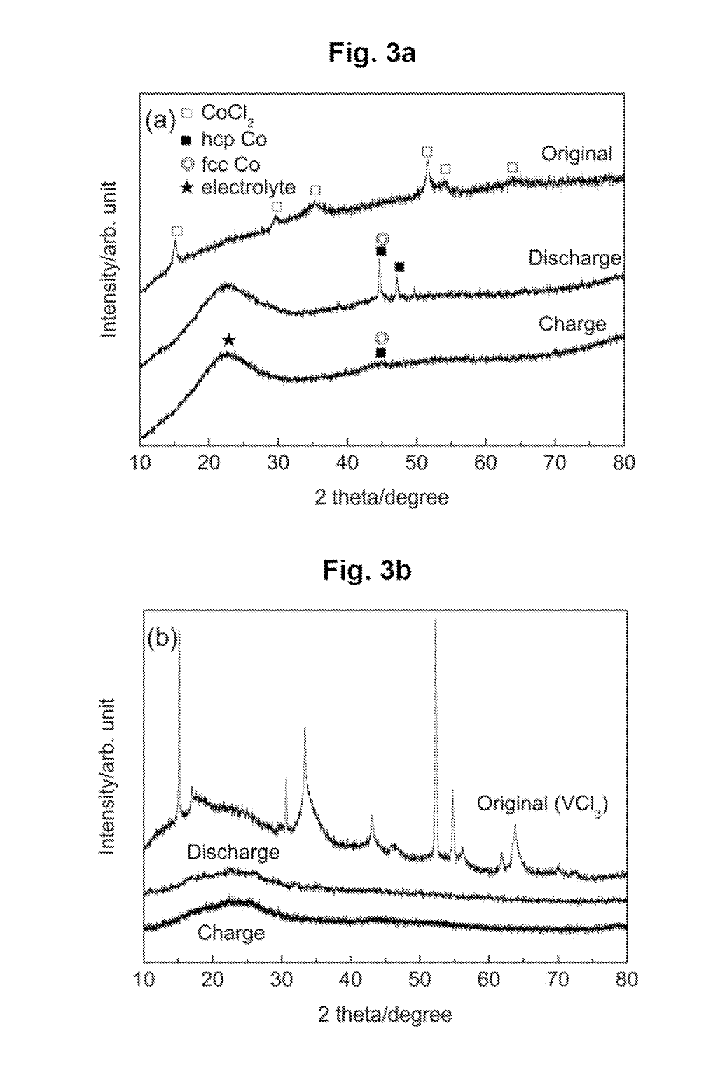

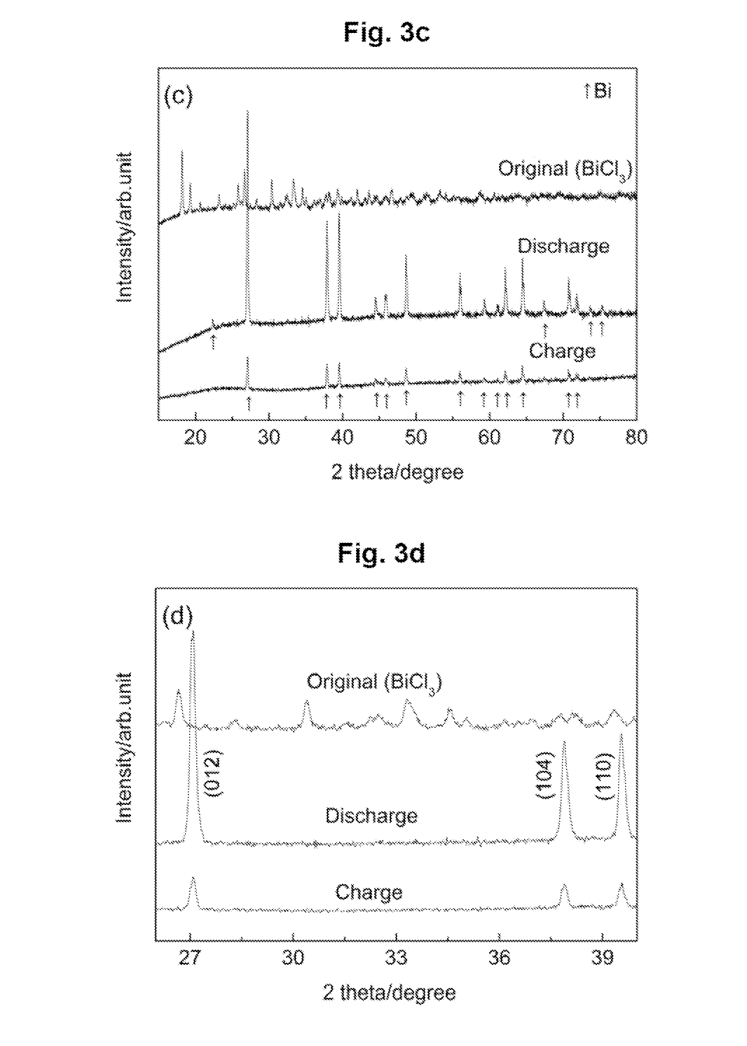

FIG. 3 presents XRD patterns of various cathode materials after discharge and charge. For the CoCl₂/Li battery, Co metal is formed by a reduction of CoCl₂ during discharge and its diffraction peaks almost disappear during charging, which may be reflected by a combination of Co metal and a chloride ion Cl⁻. Mo diffraction peaks corresponding to CoCl₂ were, however, observed in the XRD pattern according to FIG. 3a which is explained by a formation of amorphous and/or nanoscale chloride particles. Similar phenomena could be observed for conversion reactions of CoCl₂, CoF₂ or CoN as the electrode in lithium ion batteries. The broad diffraction peak at 22.6° in FIG. 3a is assigned to a reflection of the electrolyte since it is rather difficult to remove the electrolyte from the surface of an active material without dissolving the active material.

FIG. 3b shows XRD patterns of a VCl₃ cathode. Only the diffraction peak of the electrolyte appears after discharge, suggesting that V metal, which exhibits poor crystallinity being much weaker than that of Co, was formed by an electrochemical reduction of VCl₃. On the contrary, Bi metal, which was formed after discharging, exhibits sharp diffraction peaks as shown in FIG. 3c. This is explained by a phase transition from the bismuth clusters Bi₅³⁺ and Bi₅⁺ mentioned above. Similar to the charged state of the CoCl₂ electrode, BiCl₃ could also not be detected by XRD in the charged electrode. As presented in FIG. 3d, however, the intensity of the Bi metal peaks, especially the peak corresponding to the (012) plane, is drastically decreased and several diffraction peaks disappear in FIG. 3c by the reversible oxidation reaction shown in the CV patterns which again points to the formation of amorphous and/or nanoscale product phases.

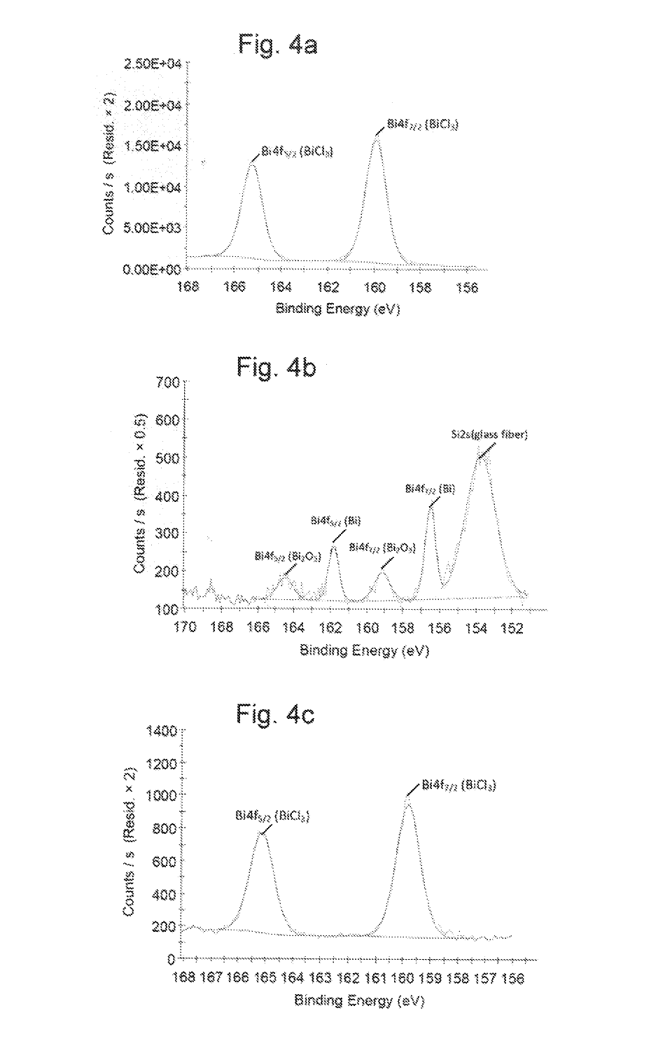

FIGS. 4a to 4c directly demonstrate the operation of a metal chloride/metal secondary battery according to the present invention.

The XPS data in FIG. 4a show 4f_{7/2} and 4f_{5/2} signals of Bi which were generated at the surface of a BiCl₃ cathode material.

FIG. 4b shows that metallic Bi^{o} was formed after discharging of the BiCl₃ cathode material. The oxide also found here is interpreted as a partial surface oxidation of Bi during the transfer of the sample from glove box to XPS chamber.

FIG. 4c finally demonstrates that metallic Bi^{o}, which had been formed during the discharging, was again reversed into BiCl₃ after recharging the battery.

The present invention is not limited to embodiments described herein; reference should be had to the appended claims.

What is claimed is:

1. A secondary battery comprising:
a negative electrode (anode) comprising at least one of a first metal, a first alloy, and a host material, which reacts with or intercalates a chloride ion as an anode material;
a positive electrode (cathode) comprising at least one of a chloride of a second metal, of a second alloy, and a chloride intercalation compound, as a cathode material;
a separator configured to separate the cathode material from the anode material; and
an electrolyte with a chloride ionic conductivity.

2. The secondary battery as recited in claim 1, wherein the chloride ionic conductivity equals or exceeds a value of 0.1 mS cm⁻¹.

3. The secondary battery as recited in claim 1, wherein the anode material comprises at least one of an alkaline metal, an alkaline earth metal, a rare earth metal, and an alloy which includes at least one of an alkaline metal, an alkaline earth metal, and a rare earth metal.

4. The secondary battery as recited in claim 1, wherein the cathode material includes a chloride of at least of a single transition metal and at least a single post-transition metal.

5. The secondary battery as recited in claim 1, wherein at least one of the anode material and the cathode material comprises a composite comprising at least one of carbon black, a nanocarbon, a metal powder, and a metal foam.

6. The secondary battery as recited in claim 5, wherein the cathode material comprises a solid mixture of at least one of CoCl₂, VCl₃, and BiCl₃, respectively, with carbon black.

7. The secondary battery as recited in claim 1, wherein the electrolyte is selected from at least one of a chloride ionic liquid, a mixture of a complex anion comprising a chloride ion and an organic solvent, an ionic liquid, an organic chloride salt, and an inorganic chloride salt.

8. The secondary battery as recited in claim 7, wherein the chloride ionic liquid is selected from a first binary chloride ionic liquid comprising a cation of at least one of imidazolium, pyrrolidinium, piperidinium, pyridinium, and a quaternary ammonium.

9. The secondary battery as recited in claim 8, wherein an organic solvent or a second ionic liquid comprising an anion which is different from the first binary chloride ionic liquid is added as a solvent to the first binary chloride ionic liquid.

10. The secondary battery as recited in claim 7, wherein the complex anion includes at least one of [FeCl₄]⁻, [FeCl₄]²⁻, [NiCl₄]²⁻, and [CoCl₄]²⁻.

11. The secondary battery as recited in claim 7, wherein the organic chloride salt is selected from at least one of a poly(diallyldimethylammonium chloride), and from an organic chloride comprising a cation of at least of imidazolium, pyrrolidinium, piperdinium, and pyridinium, with or without at least a single side chain.

12. The secondary battery as recited in claim 7, wherein the inorganic chloride salt is selected from at least one of a solid solution of a PbCl₂/alkali-metal chloride, a solid solution of a SnCl₂/alkali-metal chloride, CsSnCl₃, CsPbCl₃, K₂NiCl₄, LaOCl, and La₁₋ₓCaₓOCl₁₋ₓ.

13. A method of manufacturing a secondary battery as recited in claim 1, the method comprising:
(a) providing an anode material comprising at least one of a first metal, a first alloy, and a host material, which reacts with or intercalates a chloride ion so as to form a negative electrode (anode) therewith;
(b) providing a cathode material comprising at least one of a chloride of a second metal, a second alloy, and a chloride intercalation compound, so as to form a positive electrode (cathode) therewith;
(c) arranging a separator so that the positive electrode (cathode) is physically separated from the negative electrode (anode) when a flow of chloride ions is allowed during an operation of the secondary battery; and
(d) adding an electrolyte so that the positive electrode (cathode) is electrically connected with the negative electrode (anode).

14. The method as recited in claim 13, wherein the cathode material provided in step (b) is provided in a form of a dried powder, the positive electrode (cathode) being formed by ball milling the dried powder with at least one of a carbon black and with a nanocarbon.

15. The method as recited in claim 13, wherein the cathode material provided in step (b) is provided in a form of a dried powder dissolved in a solution, the dried powder dissolved in the solution being subsequently added to carbon black or a nanocarbon so as to provide a wet composite, the positive electrode (cathode) being formed by freeze-drying and subsequently heating the wet composite.
